(19) United States
(12) Patent Application Publication
(10) Pub. No.: US 2009/0304934 A1
(43) Pub. Date: Dec. 10, 2009

(54) METAL PLATING

(75) Inventors: Jerry Finney, Hickory, NC (US); Bennett Fisher, Morganton, NC (US); Nelson Oakes, Uniondale, PA (US); Jerry Perry, Trion, NC (US)

Correspondence Address: FOLEY HOAG, LLP;PATENT GROUP, WORLD TRADE CENTER WEST, 155 SEAPORT BLVD, BOSTON, MA, 02110, US

(73) Assignee: Carolina Silver, LLC, Maiden, NC (US)

(21) Appl. No.: 12/479,355

(22) Filed: Jun. 5, 2009

Related U.S. Application Data
(60) Provisional application No. 61/059,455, filed on Jun. 6, 2008.

(51) Int. Cl. B05D 3/00; B05C 3/12

(52) U.S. Cl. 427/299; 118/429

(57) ABSTRACT

A package plating machine may be used to metal-plate yarn directly on the package. Similar devices and methods can be used for metal-plating other materials, including staple fiber or tow fiber in a basket and woven, nonwoven or knitted fabric on a beam.

### CROSS-REFERENCE TO RELATED APPLICATION

This application claims the benefit of U.S. Provisional application No. 61/059,455, filed Jun. 6, 2008, which is hereby incorporated herein by reference.

### BACKGROUND

Yarn is typically provided in “package” form: i.e., wound on a tube. Metal plating of the yarn is typically carried by first unwinding the yarn from the package, knitting the yarn into a sleeve, metal-plating the sleeve, deknitting the sleeve to yield plated yarn, and winding the plated yarn back onto a tube to create a plated package. The unwinding, knitting, deknitting, and winding process is time consuming and stressful to the yarn (especially the knitting and deknitting), causing troublesome and costly breaks in yarn filaments.

### SUMMARY

Devices and methods for metal-plating yarns are disclosed that do not involve the unwinding, knitting, deknitting, and winding steps. The inventors have developed a package plating machine that may be used to metal-plate yarn directly on the package. Similar devices and methods can be used for metal-plating other materials, including staple fiber or tow fiber in a basket and woven, nonwoven, or knitted fabric on a beam.

### BRIEF DESCRIPTION OF THE DRAWINGS

FIG. 1 is a schematic diagram of a plating machine.

FIG. 2A is a schematic of the plating machine with solution flowing outside-in.

FIG. 2B is a schematic of the plating machine with solution flowing inside out.

FIG. 3A is a schematic of the pump assembly with solution flowing outside-in.

FIG. 3B is a schematic of the pump assembly with solution flowing inside-out.

FIG. 4 is a flowchart describing a method of plating with an optional post-activation moisture-extraction step.

FIG. 5 is a flowchart describing a method of plating without a post-activation moisture-extraction step.

### DETAILED DESCRIPTION

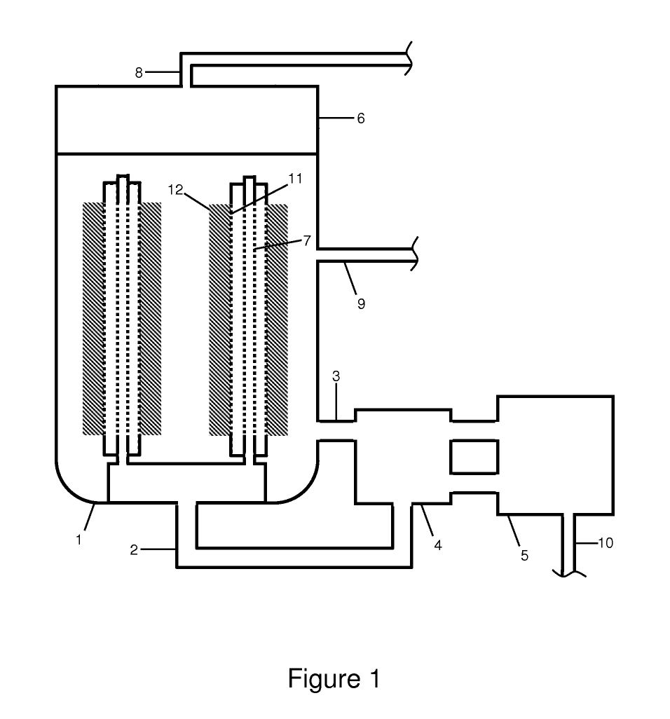

FIG. 1 is a schematic diagram of one embodiment of a plating machine. A kier 1 is connected by two pipes, a spindle pipe 2 and a kier pipe 3, to a reversing (or “switch” or “four-way”) valve 4. The reversing valve 4 is connected to a pump 5. The kier may have an openable lid 6. Inside the kier is at least one hollow perforated spindle 7. The spindle pipe 2 is in fluid (i.e., liquid) communication with interiors of the spindles 7. The kier pipe 3 is in fluid communication with the interior of the kier 1 and the exterior of the spindles 7. The kier 1 may be supplied with water (such as deionized water) through one or more spigots in the fluid path, such as top spigot 8 in the lid and side spigot 9 on the kier 1. The pump 5 may be equipped with a drain 10 for removing fluid from the system. The machine is shown with perforated carrier 11 mounted on the spindles 7. The carrier shown is a dye tube 11 and is wound with yarn 12.

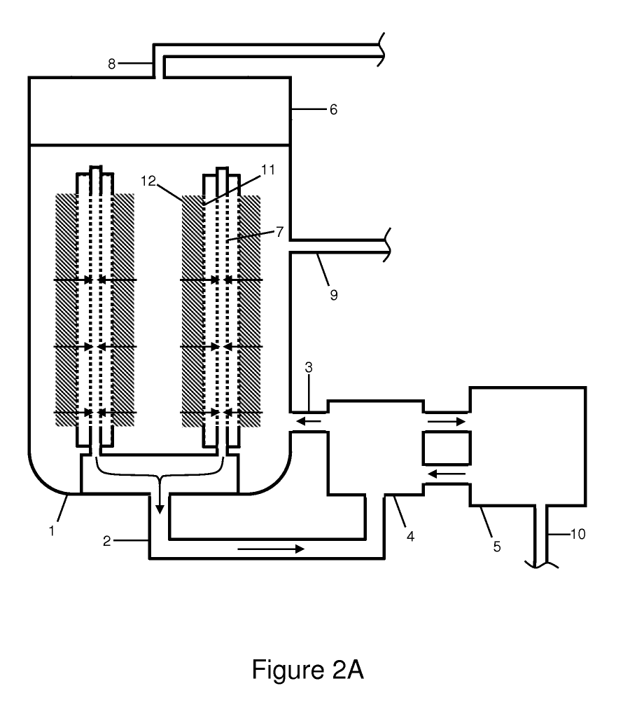

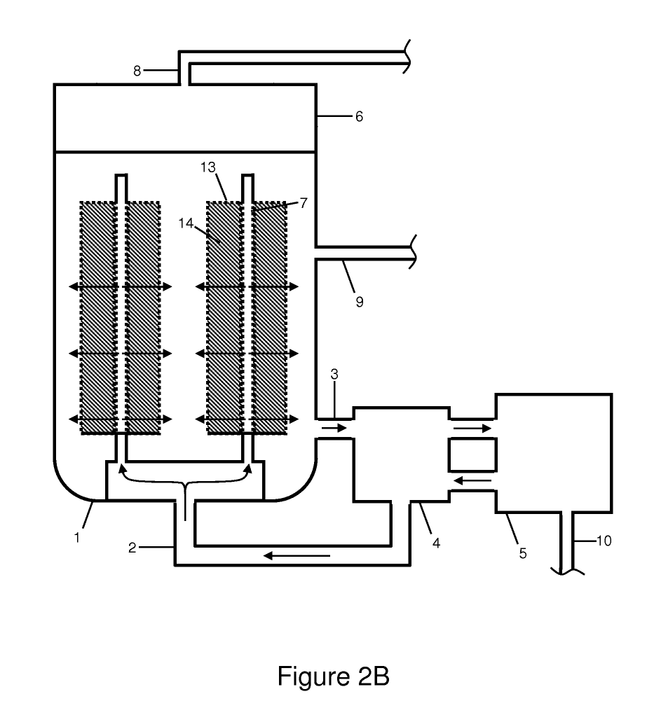

FIG. 2A is a schematic diagram of the same plating machine operating with “outside-in” fluid flow, where the flow is depicted with arrows. When the machine is operating “outside-in,” the pump 5 drives fluid into the reversing valve 4, which directs the flow into the kier pipe 3. From the kier pipe 3 the flow proceeds into the kier 1, through the substrate (shown here as yarn 12), through the perforations of the mounted carrier (shown as dye tube 11), through the spindle perforations into the interior of the spindles 7, into the spindle pipe 2, back to the reversing valve 4, and finally back to the pump 5, completing the fluid circuit. This flow pattern is called “outside-in” flow because the fluid flows from outside the spindle to inside the spindle. In normal operation, one or more carriers loaded with yarn, staple fiber, or fabric (collectively, “substrate”) to be metal-plated are placed in the kier and positioned on the spindles (as described in more detail below). In this way, the substrate is intimately exposed to liquids forced through the spindles under pressure.

FIG. 2B is a schematic diagram of the same plating machine operating with “inside-out” fluid flow, where again the flow is depicted with arrows. When the machine is operating “inside-out,” the pump 5 drives fluid into the reversing valve 4, which directs the flow into the spindle pipe 2. From the spindle pipe 2 the flow proceeds to the interior of the spindles 7, through the perforations of the spindle 7 and the carrier (shown here as basket 13), through the substrate (shown here as staple fiber or tow fiber 14), into the kier 1, into the kier pipe 3, back to the reversing valve 4, and finally back to the pump 5, completing the fluid circuit. This flow pattern is called “inside-out” flow because the fluid flows from inside the spindle to outside the spindle.

The plating machine schematically shown in FIGS. 1, 2A and 2B is based on existing package and beam dyeing machines modified to fit the needs of the plating process. Existing package dyeing machines typically include a kier, a pump, a reversing valve, and a hollow perforated spindle just like the plating machine of FIG. 1. Yarn wound onto a perforated dye tube can be loaded into such a dyeing machine and mounted on the spindle. The tube and the spindle are designed so that when fluid is forced into or out of the spindle, the fluid is also forced through the yarn wound on the mounted perforated dye tube. Stated more generally, a hollow, perforated substrate-loaded carrier is mounted on a hollow perforated spindle, and various fluids are pumped and directed through substrate under pressure. But traditional dyeing machines typically also include additional elements such as heat exchangers, expansion tanks and add tanks, as well as all the extra piping necessary to connect these additional elements. Dyeing machines include these extra parts because they are essential for many dyeing processes; for example, dyeing often involves chemical reactions between dye and yarn that are carried out at elevated temperatures, so dyeing machines include heat exchangers. Those temperatures often exceed the boiling point of water at standard pressure, so dyeing machines include air compressors.

The plating machine of FIG. 1 differs from a typical package dyeing machine in that (a) it does not include any additional elements such as a heat exchanger, air compressor, expansion tanks and add tanks, and (b) the amount of piping in the machine has been minimized. In modifying a package dyeing machine to make a plating machine, it is beneficial to remove or (at least make inaccessible to liquid in the system) unnecessary elements and also to minimize piping. Removing unnecessary elements and excess tubing from the plating machine reduces the internal surface area onto which the plating solution can deposit the plating metal; the goal of using the plating machine is, of course, to deposit the plating metal on a textile substrate, not on the interior surfaces of the plating machine. In some embodiments it may be beneficial to retain an expansion tank or add tank in the system to provide a convenient way of adding certain reagents during the plating process, despite the added internal surface area.

The plating machine can be configured for “package plating,” i.e., plating metal onto yarn that has been wound on a hollow perforated dyeing tube. Existing plating methods require that the yarn first be unwound from a package, knitted into fabric (term a “sleeve”), which fabric is then taken through a traditional electroless plating process, then de-knitted and re-wound. Every manipulation stresses the yarn, and the resulting plated yarn is replete with strand breaks and other imperfections. The present systems and methods permit plating of unknitted and unwoven yarn without subjecting it to the stress of unwinding, knitting, deknitting, and rewinding, and thus can minimize breakage. The plating machine can also be configured to plate a beam of woven fabric, nonwoven fabric (i.e., sheet or web structures bonded together by entangling fiber or filaments mechanically, thermally or chemically), or knitted fabric, where the fabric is wrapped onto a hollow perforated tube. The plating machine can also be configured to plate staple fiber that has not been spun into yarn but rather caged in a perforated basket for plating. Both beams and baskets should be perforated so that, when they are mounted on the spindle, fluid forced into or out of the spindle is also forced through the fabric or staple fiber.

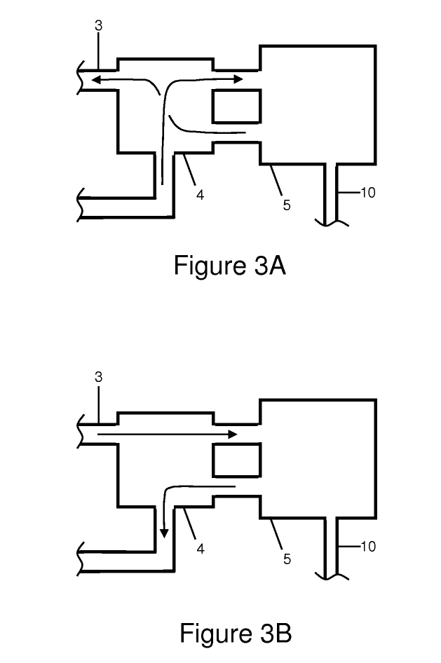

FIGS. 3A and 3B show the pump and reversing valve operating in outside-in and inside-out modes respectively. The pump always drives flow in the same sense, while the reversing valve directs the flow either into the kier pipe 3 in the case of outside-in flow, or into the spindle pipe 2 in the case of inside-out flow.

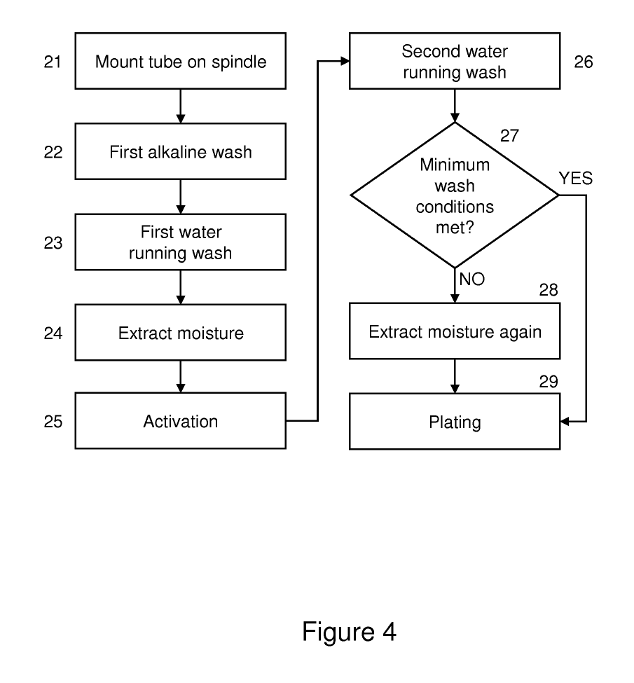

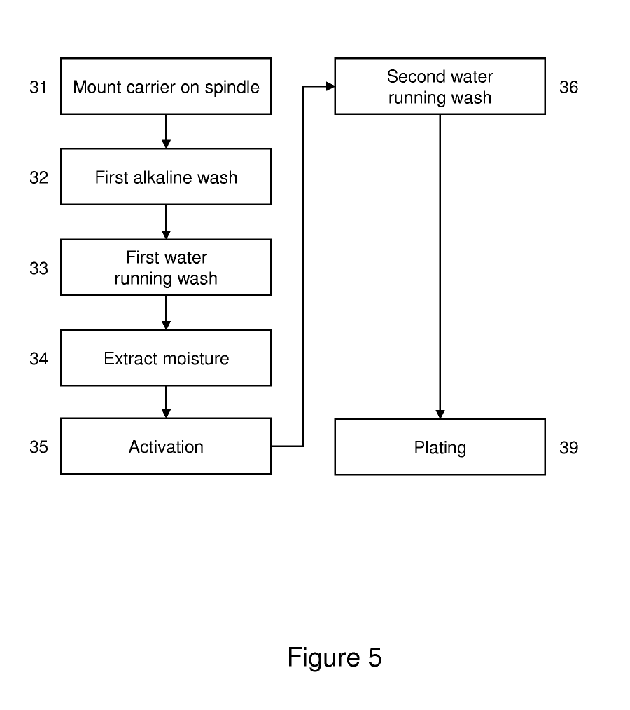

FIGS. 4 and 5 are flowcharts describing methods of plating. FIG. 4 describes a method of plating wherein the carrier is a dye tube, and in which a post-activation moisture removal step 28 may be skipped, depending on the satisfaction of certain washing criteria. FIG. 5 describes a similar method of plating wherein the type of carrier used is not specified, and in which there is no post-activation moisture removal step.

The plating process involves three key steps: (a) washing, (b) activation, and (c) plating. In all three steps and in the related rinses described below, a carrier loaded with some substrate, typically staple fiber, yarn or knitted or woven fabric, is mounted on a spindle inside the kier of a plating machine. In all the following steps in which fluid is circulated both outside-in and inside-out, it is preferred but not necessary to begin the process with outside-in flow. This has been found to bring the fluid to an equilibrium state and into intimate contact with all the substrate more quickly than if the process begins with inside-out circulation. Fluids used in the plating process can be circulated at a wide variety of pressures, such as from 10 to 40 pounds per square inch; good results have been achieved with fluid pressures at or around 20 pounds per square inch. Substrate plating is remarkably uniform despite hundreds or even thousands of substrate layers, because fluid pumped under such pressure through the spindle and carrier can fully contact and interact with all or nearly all substrate surfaces.

A. Washing

After being loaded into the plating machine and mounted on a spindle, the substrate is washed to remove contaminants, such as oils, as follows. A wide variety of scouring techniques may be employed. For example, the substrate may be submerged in an aqueous alkaline solution of surfactant such as sodium laurel sulfate (SLS). Alkalinity can be provided by an alkaline agent such as sodium hydroxide, soda ash, tetrasodium pyrophosphate, among many others. A wash solution containing 1 gram of SLS per pound of substrate and 7.5 grams of 50% weight by volume NaOH solution per pound of substrate has been found to clean a nylon yarn substrate effectively at a temperature of 100° F. Once the substrate is submerged, the machine is closed and the pump is engaged to circulate the wash solution. The solution may be pumped in both directions, outside-in and inside-out, to ensure thorough contact between the substrate and the wash solution. The wash solution is then drained.

After washing, the substrate is rinsed in place on the spindle with a water running-wash (meaning that as the rinse proceeds, circulated water is continually drained and new water continually added) to remove residual surfactant and alkali. The water is typically deionized. After the water running wash, moisture may then be extracted from the substrate-loaded carrier. Moisture can be extracted by spin extraction, vacuum extraction, heating, blow-drying, or combinations of these techniques. Sufficient moisture should be removed such that the mass of the loaded carrier is brought to less than 10%, preferably 6%, in excess of its pre-wash mass.

B. Activation

If the package was removed from the machine for moisture extraction, it is remounted on the spindle. Activator solution is then added to the machine. The composition and temperature of the activator solution depend on many factors, primarily the type of substrate and the particular metal to be plated. For plating silver onto a nylon substrate, an exemplary plating solution includes 1% to 6% weight by volume hydrochloric acid (HCl) (or 2% to 5%, 3% to 4%, 1% to 5%, 2% to 6%, about 1%, about 2%, about 3%, about 4%, about 5%, or about 6% HCl) and 100 to 1,000 grams of stannous chloride (SnCl₂) per thirty gallons of activating solution (or 600 to 1,000 grams, 100 to 800 grams, 200 to 800 grams, 200 to 600 grams, 300 to 500 grams, 300-400 grams, 400-500 grams, about 300 grams, about 400 grams, about 500 grams, or about 600 grams of SnCl₂ per thirty gallons of activating solution). With the substrate submerged in activator solution, the machine is briefly run outside-in and inside-out to etch the yarn fibers and deposit the tin within the etched areas. The machine can be run in each direction for 10 seconds to 2 minutes, 10 seconds to 1 minute, 20 seconds to 1 minute, 30 seconds to 90 seconds, 20 seconds to 100 seconds, about 10 seconds, about 20 seconds, about 30 seconds, about 40 seconds, about 50 seconds, about 1 minute, about 70 seconds, about 80 seconds, about 90 seconds, about 100 seconds, about 110 seconds, or about 2 minutes. The activator solution is then drained from the machine.

After activation, the substrate is rinsed in place on the spindle in a second water wash (circulating and/or running wash). For example, a brief water circulating wash can be run to dilute the activator solution sufficiently to halt the etching, followed by a running wash to remove the activator solution. The second water running-wash can be as short as 15 seconds in each direction and should not exceed 8 minutes total (i.e., 4 cycles of 1 minute outside-in and 1 minute inside-out).

After the second water running-wash, the process may or may not involve a second moisture extraction step. If the moisture extraction step is required, the loaded carrier should be brought to less than 15%, preferably 10%, more preferably 8%, in excess of its pre-wash mass. In some cases this second moisture extraction step is not required. If the second moisture extraction is to be skipped, two minimum conditions must be met. First, after the pre-activation alkaline wash step, the amount of residual contaminants remaining on the substrate-loaded carrier must be less than 2%, preferably 1%, by weight, as determined by Soxhlet extraction. Second, the second water running-wash must have included pumping the water for at least one minute in each direction, outside-in and inside-out. If these two minimum wash conditions are met, the plating step can immediately follow the second water wash with no intervening moisture extraction.

C. Plating

If the washed and activated substrate was removed from the plating machine for moisture extraction, it is re-mounted on the spindle. Plating solution is added to the machine; the pump may be briefly engaged in both directions to coat the substrate with the metal compound in the plating solution. As with the activator solution, the ideal composition and temperature of the plating solution will vary, depending primarily on the type of substrate, the particular metal to be plated, and the amount of metal to be plated per unit mass of substrate. For plating silver on nylon, the plating solution will contain silver nitrate (AgNO₃), ammonia (NH₃) and a surfactant (such as SLS). One such exemplary solution for plating silver on nylon contains, per pound of substrate to be plated, 0.5 pounds of 50% weight by volume silver nitrate (AgNO₃), 0.2 pounds of 26° baumé ammonia (NH₃), and 0.199 pounds of SLS. Once the substrate is coated with plating solution, an initiator, such as formaldehyde, is then added to the plating solution to cause plating to commence, either by adding it directly to the plating solution or else through an expansion or add tank, if available. After the initiator is added, the pump is run in cycles of alternating directions until the plating reaction goes to the desired amount of completion. A typical run of alternating cycles includes ten seconds in each direction up to twelve times, followed by two minutes in each direction repeated up to twelve times.

After plating, the plating effluent is drained (and optionally retained for later reclamation of the residual plating metal), and the package is rinsed in a running wash and dried.

Where the carrier was a package loaded with yarn, the result of the above process is a package loaded with uniformly plated yarn that has not been subjected to unwinding, knitting, deknitting, and winding, and therefore is essentially free of filament breaks arising after the initial yarn production. The metalized yarn may be transferred to a different package, such as a tube or a cone, for subsequent uses, such as weaving or knitting. Where the carrier was a beam, the result is plated fabric. Where the carrier was a basket loaded with staple or tow fiber, the result is plated fiber which is then ready to be spun into plated yarn or to be blended with other fibers. Processing tow fiber then permits cutting the plated fiber to any length desired or suitable for a given purpose.

### Example

To demonstrate feasibility of the method, a tabletop dyeing machine (from Gaston County Dyeing Machine Co.) was modified as described above. All tubing was removed from the machine. Lengths of tubing as short as possible were restored to connect the main tank with the pump and to connect the expansion tank with the pump.

A 1.3-lb 30-denier, 10-filament-count (“ 30/10”) nylon yarn package was placed in the main tank (also termed the “kier” or “dyeing vessel” or “vessel”) of the modified machine. It was washed in washing solution for 1 minute (30 seconds outside-in, followed by 30 seconds inside-out). It was then rinsed in a running wash (2 minutes outside-in, then 2 minutes inside-out), and then moved to a spin-extractor for drying to within 6% excess of its original mass.

As the nylon yarn was to be silver plated, the activator solution used contained hydrochloric acid (HCl) and stannous chloride (SnCl₂). The temperature of the activator solution, and the amounts of HCl and SnCl₂ in it, may vary on a variety of factors but will typically fall in the ranges of temperature 75°±5° F., HCl 1-6% w/v, and SnCl₂ 600-1,000 grams per 30 gallons of solution. Activator solution was added to the vessel, and the plating machine was run (10 seconds outside-in, then 10 seconds inside-out). The activator solution was drained and the package rinsed in a running wash (2 cycles of 15 seconds outside-in and 15 seconds inside-out). The package was then moved to the spin extractor and dried to 8% excess weight.

The package was returned to the vessel. Plating solution for plating silver on nylon yarn was used and included silver nitrate (AgNO₃), ammonia (NH₃), and surfactant (such as SLS). The relative amounts of these reagents vary depending on the desired extent of silver plating. In this particular case, the nylon yarn was plated to 20% silver by weight, and the plating solution was composed of, per pound of input yarn, 0.5 lb. 50% w/v silver nitrate (AgNO₃), 0.2 lb. ammonia (NH₃) 26° baume, and 0.199 lb SLS. Plating solution was added in sufficient volume to submerge the package. The plating machine was then run 10 seconds outside-in and 10 seconds inside-out. Initiator (formaldehyde (H₂CO); for 20% silver plating, 0.22 lb formaldehyde per pound input yarn), having been placed in the expansion tank with enough water to cause the final plating solution to make the vessel completely full, was then added to the plating solution by opening a valve to admit the contents of the expansion tank to the pump circulation. The pump was then run for 6 cycles of 10 seconds outside-in and 10 seconds inside-out, then 7 cycles of 2 minutes outside-in and 2 minutes inside-out. The package was then rinsed in a running wash (5 minutes inside-out, then 5 minutes outside-in) and dried to essentially complete dryness in the spin extractor.

The entire process to silver plate 1.3 lb of nylon yarn using the modified machine took one hour. In comparison, silver-plating the same amount of nylon yarn by the unwinding, knitting, plating, deknitting, and winding process takes 15 hours.

The tabletop process described here can be readily scaled up for production purposes and can be applied to a wide variety of yarns and metals.

We claim:

1. A method of silver plating nylon yarn, the method comprising:
with a dyeing machine that comprises an expansion tank, a heat exchanger, a pump assembly comprising a pump and a reversing valve, a hollow perforated spindle, and a kier in which the spindle is positioned: modifying the dyeing machine by removing the heat exchanger and forming a fluid circuit from the pump assembly to the hollow perforated spindle to the kier to the pump assembly;
mounting a dyeing tube on the spindle, the dyeing tube comprising a hollow perforated core sized and shaped to be mounted on the spindle, the dyeing tube being wound with unknitted and unwoven nylon yarn;
pumping the following solutions through the fluid circuit alternating between two directions so that the solutions are forced into contact with the nylon yarn, one direction being outside-in, from the kier into inside the spindle, and the other direction being inside-out, from inside the hollow perforated spindle out to the kier:
a first aqueous alkaline wash solution that comprises a surfactant; then
a first water running wash to remove residual alkaline wash solution;
extracting moisture from the nylon yarn to a moisture content of less than 10% by mass; and
pumping the following solutions through the fluid circuit alternating outside-in and inside-out so that the solutions are forced into contact with the nylon yarn:
an activating solution comprising 1% to 6% weight by volume hydrochloric acid and 100-800 grams of stannous chloride per 30 gallons of activating solution; then
a second water running wash to remove residual activating solution; then
a plating solution comprising silver nitrate, ammonia, an initiator, and a surfactant.

2. The method of claim 1, wherein the first alkaline wash reduces residual contaminants in the nylon yarn to less than 2% by weight as determined by Soxhlet extraction.

3. The method of claim 2, wherein the second water running wash is followed by the plating solution with no intervening moisture extraction.

4. The method of claim 3, wherein the second water running wash is pumped through the fluid circuit for one to four repetitions of outside-in and inside-out, each repetition from one to two minutes in duration.

5. The method of claim 1, further comprising extracting moisture from the nylon yarn to a moisture content of less than 15% by mass after pumping the second water running wash but before pumping the plating solution.

6. The method of claim 1 wherein pumping comprises first pumping outside-in, then pumping inside-out.

7. A method of silver plating nylon, the method comprising:
mounting a carrier in a plating machine, the plating machine comprising a pump assembly comprising a pump and a reversing valve, a hollow perforated spindle on which the carrier is mounted, and a kier in which the spindle is positioned, the plating machine forming a fluid circuit from the pump assembly to the spindle to the kier to the pump assembly, the carrier comprising a hollow perforated core sized and shaped to be mounted on the spindle, the carrier being loaded with nylon;
pumping the following solutions through the fluid circuit alternating between two directions so that the solutions are forced into contact with the nylon, one direction being outside-in, from the kier into inside the spindle, and the other direction being inside-out, from inside the hollow perforated spindle out to the kier:
a first aqueous alkaline wash solution that comprises a surfactant; then
a first water running wash to remove residual alkaline wash solution;
extracting moisture from the nylon to a moisture content of less than 10% by mass; and
pumping the following solutions through the fluid circuit alternating outside-in and inside-out so that the solutions are forced into contact with the nylon:
an activating solution comprising 1% to 6% weight by volume hydrochloric acid and 100-800 grams of stannous chloride per 30 gallons of activating solution; then
a second water running wash to remove residual activating solution; then
a plating solution comprising silver nitrate, ammonia, an initiator, and a surfactant, wherein the plating solution follows the second water running wash with no intervening moisture extraction.

8. The method of claim 7, further comprising making the plating machine by modifying a dyeing machine that comprises an expansion tank, a heat exchanger, the pump assembly, the spindle, and the kier, by removing the heat exchanger and forming the fluid circuit.

9. The method of claim 7, wherein the nylon is unwoven and unknitted nylon yarn and the carrier comprises a perforated dyeing tube.

10. The method of claim 7, wherein the nylon is knitted, nonwoven, or woven fabric comprising nylon yarn and the carrier comprises a perforated beam.

11. The method of claim 7, wherein the nylon is nylon staple fiber and the carrier comprises a perforated basket.

12. The method of claim 7 wherein pumping comprises first pumping outside-in, then pumping inside-out.

13. A plating machine comprising:
a pump assembly comprising a pump and a reversing valve;
a hollow perforated spindle;
a kier in which the spindle is positioned, wherein a fluid circuit is defined from the pump assembly to the spindle to the kier to the pump assembly;
a carrier comprising a hollow perforated core, the carrier being loaded with nylon, and the carrier being mounted on the spindle; and
a quantity of plating solution in the fluid circuit, the plating solution comprising silver nitrate, ammonia, an initiator, and a surfactant.

14. The machine of claim 13, wherein the nylon is unwoven and unknitted nylon yarn and the carrier is a perforated dyeing tube.

15. The machine of claim 13, wherein the nylon is knitted, nonwoven, or woven fabric comprising nylon yarn and the carrier is a perforated beam.

16. The machine of claim 13, wherein the nylon is nylon staple fiber and the carrier is a perforated basket.
